(19) United States
(12) Patent Application Publication
(10) Pub. No.: US 2023/0091128 A1
(43) Pub. Date: Mar. 23, 2023

(54) CONTROL DEVICE, IMAGE FORMING SYSTEM, CONTROL METHOD, AND RECORDING MEDIUM

(71) Applicant: KONICA MINOLTA, INC., Tokyo (JP)

(72) Inventors: Hiroshi YAMAGUCHI, Tokyo (JP); Masayuki WATANABE, Tokyo (JP); Hiroshi OYAMA, Tokyo (JP); Hidenori MINE, Tokyo (JP); Takanobu SHIKI, Sagamihara-shi (JP); Kyouhei KUBOTA, Sagamihara-shi (JP); Kazuya OGIWARA, Tokyo (JP)

(73) Assignee: KONICA MINOLTA, INC., Tokyo (JP)

(21) Appl. No.: 17/941,249

(22) Filed: Sep. 9, 2022

(30) Foreign Application Priority Data
Sep. 16, 2021 (JP) 2021-151173

(51) Int. Cl. G03G 15/00

(52) U.S. Cl. CPC G03G 15/6573; G03G 15/6517; G03G 2215/00772

(57) ABSTRACT

A control device of an image forming system including an image former that forms an image on a recording medium formed of a continuous sheet or a long sheet includes a hardware processor that calculates a width of the recording medium on a downstream side of a fixer included in the image former in a transport direction of the recording medium and outputs a shrinkage amount or a shrinkage rate of the recording medium in the transport direction due to the fixer based on the width of the recording medium and shrinkage characteristic information of the recording medium.

### CROSS-REFERENCE TO RELATED APPLICATIONS

The entire disclosure of Japanese Patent Application No. 2021-151173 filed on Sep. 16, 2021 is incorporated herein by reference in its entirety.

### BACKGROUND

### Technological Field

The present invention relates to a control device, an image forming system, a control method, and a recording medium.

### Description of the Related Art

In an image forming apparatus, a formed image is fixed by heating after image formation. At this time, shrinkage may occur due to heating. For this reason, in a known image forming apparatus, the front end and the rear end of the paper to be transported are detected by sensors, the elapsed time from the passage of the front end to the passage of the rear end is calculated, and the length of the paper in the transport direction is calculated by multiplying the elapsed time by the transport speed, thereby acquiring the shrinkage amount of the paper (see, for example, JP 2006-9 1 424A).

A known image forming apparatus that forms an image on continuous paper, such as a continuous form, includes a first image former that forms an image on the front surface of the continuous paper and a second image former that forms an image on the back surface of the continuous paper, and sensors are provided on the upstream side and the downstream side of a fixer of the first image former.

Each sensor includes a mark sensor that detects detection marks formed at predetermined distances therebetween on the continuous paper and an edge sensor that detects the edge positions of both ends of the continuous paper in the width direction. Then, the shrinkage amount of the continuous paper in the transport direction is output from the elapsed time until the two detection marks are sequentially detected by the mark sensor, and the shrinkage amount of the continuous paper in the width direction is output from the edge positions of both ends in the width direction detected by the edge sensor (see, for example, JP 2018-2314A).

### SUMMARY

The image forming apparatus disclosed in JP 2006-91424A has a configuration in which the front end and the rear end of the paper are detected by sensors when detecting the shrinkage amount of the paper in the transport direction. Therefore, in the case of continuous paper such as a continuous form continuous in the transport direction, it is not possible to detect the front end or the rear end. For this reason, it has been difficult to detect the amount of shrinkage in the transport direction.

The image forming apparatus disclosed in JP 2018-2314A requires two sensors, one on the upstream side and the other on the downstream side of the fixer, in order to detect the shrinkage amount of the paper in the transport direction. For this reason, there has been a risk that the device size and the cost of components would increase.

On the other hand, in the case of a configuration in which the length of continuous paper in the transport direction is detected from the elapsed time until two detection marks are sequentially detected by one mark sensor, there is a problem that the shrinkage amount of the paper in the transport direction before and after the fixer cannot be detected correctly for the following reasons.

For example, a case is illustrated in which two detection marks are formed at a distance of 100 [mm] and the transport speed of a fixer 101 is set to 500 [mm/s] to detect the elapsed time until the two detection marks are detected.

As shown in FIG. 20A, when the fixer 101 is in a non-heated state and continuous paper P does not shrink, the continuous paper P is transported at a transport speed of 500 [mm/s] even on the downstream side of the fixer 101 in the transport direction. Therefore, the elapsed time until the two detection marks are detected is 100/500 = 0.2 [s].

In contrast, as shown in FIG. 20B, assuming that the continuous paper P shrinks by 1 [%] due to the heating of the fixer 101, the continuous paper P is restrained by the rollers of the fixer 101. Therefore, the transport speed decreases to 495 [mm/s] on the downstream side in the transport direction.

On the other hand, the distance between the two detection marks decreases to 99 [mm], but the elapsed time until the two detection marks are detected becomes 99/495 = 0.2 [s] due to the decrease in transport speed.

Thus, when trying to detect the shrinkage amount of the paper in the transport direction before and after fixing with one sensor for continuous paper or long paper, even if the shrinkage of the paper occurs in the transport direction, the occurrence of shrinkage cannot be detected correctly because the elapsed time until the two detection marks are detected is equal.

Although FIGS. 20A and 20B illustrate a configuration in which a paper ejection roller 102 that performs driven rotation is provided on the downstream side of the fixer 101, the result is the same even when the paper ejection roller 102 is not provided.

An object of the present invention is to appropriately grasp the shrinkage state of a recording medium, such as a continuous sheet or a long sheet, due to heating.

To achieve at least one of the abovementioned objects, according to an aspect of the present invention, a control device reflecting one aspect of the present invention is a control device of an image forming system including an image former that forms an image on a recording medium formed of a continuous sheet or a long sheet. The control device includes an outputter that calculates a width of the recording medium on a downstream side of a fixer included in the image former in a transport direction of the recording medium and outputs a shrinkage amount or a shrinkage rate of the recording medium in the transport direction due to the fixer based on the width of the recording medium and shrinkage characteristic information of the recording medium.

According to another aspect, an image forming system includes the control device described above.

According to another aspect, there is provided a control method of an image forming system including an image former that forms an image on a recording medium formed of a continuous sheet or a long sheet.

The control method includes calculating a width of the recording medium on a downstream side of a fixer included in the image former in a transport direction of the recording medium and outputting a shrinkage amount or a shrinkage rate of the recording medium in the transport direction due to the fixer based on the width of the recording medium and shrinkage characteristic information of the recording medium.

According to another aspect, a non-transitory recording medium storing a program causes a computer of an image forming system including an image former that forms an image on a recording medium formed of a continuous sheet or a long sheet to function as an outputter that calculates a width of the recording medium on a downstream side of a fixer included in the image former in a transport direction of the recording medium and outputs a shrinkage amount or a shrinkage rate of the recording medium in the transport direction due to the fixer based on the width of the recording medium and shrinkage characteristic information of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram of an image forming system according to the present embodiment;

FIG. 2 is a block diagram showing a functional system of the image forming system;

FIG. 3 is an explanatory diagram showing a flow of processing for outputting shrinkage characteristic information from a shrinkage amount outputter;

FIG. 4 is an explanatory diagram showing the grain direction of continuous paper;

FIG. 5A is a diagram showing a relationship between the thickness and the shrinkage rate of continuous paper, FIG. 5B is a diagram showing a difference in shrinkage rate depending on the grain direction of continuous paper, and FIG. 5C is a diagram showing a relationship between the water content and the shrinkage rate of continuous paper;

FIG. 6 is an explanatory diagram showing the content of a correspondence table among the thickness, the grain direction, and the shrinkage ratio;

FIG. 7 is an explanatory diagram showing the content of a correspondence table between the water content and the rate of change in shrinkage rate based on the water content;

FIG. 8 is a flowchart of an operation example (1) of the image forming system;

FIG. 9A is an explanatory diagram showing the fixing temperature of a fixing roller, and FIG. 9B is a diagram showing a relationship between the fixing temperature and the shrinkage rate;

FIG. 10A is an explanatory diagram showing the fixing pressure of a fixing roller, and FIG. 10B is a diagram showing a relationship between the fixing pressure and the shrinkage rate;

FIG. 11A is an explanatory diagram showing the fixing speed of a fixing roller, and FIG. 11B is a diagram showing a relationship between the fixing speed and the shrinkage rate;

FIG. 12A is an explanatory diagram showing the content of a correspondence table between the fixing temperature and the shrinkage rate, FIG. 12B is an explanatory diagram showing the content of a correspondence table between the fixing pressure and the rate of change in shrinkage rate, and FIG. 12C is an explanatory diagram showing the content of a correspondence table between the fixing speed and the rate of change in shrinkage rate;

FIG. 13 is a flowchart of an operation example (2) of the image forming system;

FIG. 14A is a diagram showing a relationship between the tension and the shrinkage rate of continuous paper, and FIG. 14B is an explanatory diagram showing the content of a correspondence table between the tension of continuous paper and the rate of change in shrinkage rate;

FIG. 15 is a flowchart of an operation example (3) of the image forming system;

FIG. 16 is a flowchart of an operation example (4) of the image forming system;

FIG. 17A is a plan view of continuous paper when post-processing is appropriately performed, and FIG. 17B is a plan view of continuous paper when inappropriate post-processing is performed due to the influence of shrinkage in an FD direction;

FIG. 18 is a flowchart of an operation example (5) of the image forming system;

FIG. 19 is a flowchart of an operation example (6) of the image forming system; and

FIG. 20A is an explanatory diagram showing the transport speed of continuous paper when shrinkage does not occur in a fixer, and FIG. 20B is an explanatory diagram showing the transport speed of continuous paper when shrinkage occurs in a fixer.

### DETAILED DESCRIPTION OF THE EMBODIMENTS

An image forming system according to the present embodiment will be described in detail with reference to the diagrams. The image forming system according to the present embodiment is an example of the present invention, and the present invention is not limited thereto.

### Overall Configuration Example of Image Forming System

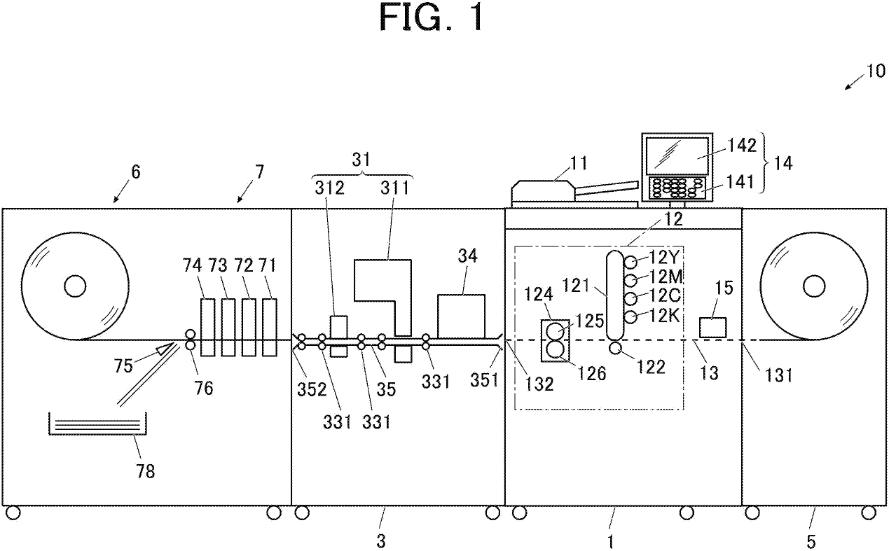

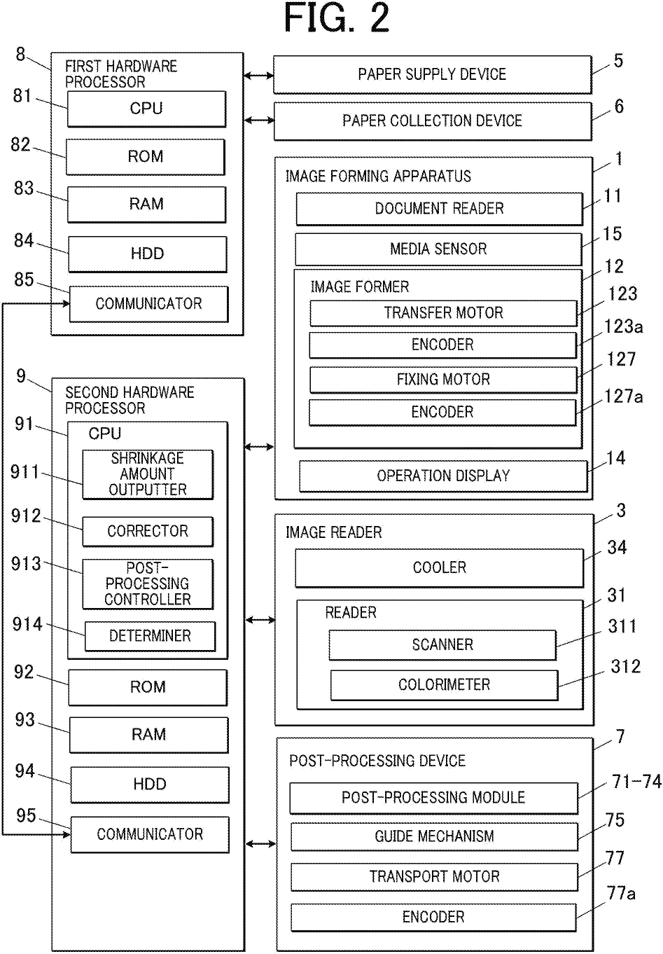

An example of the overall configuration of an image forming system 10 will be described with reference to the diagrams. FIG. 1 is a schematic diagram of the image forming system 10, and FIG. 2 is a block diagram showing a control system of the image forming system 10.

The image forming system 10 is for forming an image on a recording medium that is continuous paper P as a continuous sheet. As shown in FIGS. 1 and 2, the image forming system 10 includes a paper supply device 5, an image forming apparatus 1, an image reader 3, a post-processing device 7 as a post-processor, and a paper collection device 6 as a winder in order from the upstream of the image transport path.

The image forming system 10 includes a first hardware processor 8 that controls the paper supply device 5 and the post-processing device 7 and a second hardware processor 9 as a control device that performs overall control of the image forming apparatus 1, the image reader 3, and the post-processing device 7.

The hardware processors 8 and 9 are communicably connected to each other through communicators 85 and 95.

The continuous paper P used as a recording medium in the image forming system 10 indicates long recording paper that is continuous from the front end unwound from the roll to the rear end on the deepest side of the roll.

The continuous paper P is transported along its longitudinal direction. In the following description, the transport direction (longitudinal direction) of the continuous paper P may be referred to as an FD direction, and a direction parallel to the paper surface of the continuous paper P and perpendicular to the longitudinal direction (width direction) may be referred to as a CD direction.

### Paper Supply Device

The paper supply device 5 includes a motor as a drive source (not shown) that supports a roll on which the continuous paper P is wound before an image is formed and rotationally drives the roll in the feeding direction.

The paper supply device 5 supplies the fed continuous paper P to a paper feed port 131 of the image forming apparatus 1.

The paper supply device 5 is controlled by the first hardware processor 8 so that the tension of the continuous paper P passed from the roll to the image forming apparatus 1 by the motor as a drive source is constant.

### Paper Collection Device

The paper collection device 6 is a winder that collects the continuous paper P while winding the continuous paper P on which an image is formed and the image has been read by the image reader 3. In order to form a roll while winding the continuous paper P, the paper collection device 6 includes a motor as a drive source (not shown) for rotationally driving the roll.

The paper collection device 6 is arranged on the downstream side of the post-processing device 7 in the transport direction of the continuous paper P, and collects the continuous paper P that has passed through the post-processing device 7.

The paper collection device 6 is controlled by the first hardware processor 8 so that the tension of the continuous paper P wound from the image reader 3 side by the motor as a drive source is constant.

### Image Forming Apparatus

As an example of the image forming apparatus 1, an electrophotographic image forming apparatus such as a copying machine can be mentioned. As shown in FIG. 1, the image forming apparatus 1 is also called a so-called tandem type color image forming apparatus. By arranging one intermediate transfer belt so as to extend along a predetermined direction (vertical direction in the present embodiment) and arranging a plurality of photoconductor drums facing the intermediate transfer belt in the extending direction of the belt, it is possible to form a full-color image on the intermediate transfer belt.

As shown in FIGS. 1 and 2, the image forming apparatus 1 includes, for example, a document reader 11, an image former 12, a first transport path 13, and an operation display 14. The units of the image forming apparatus 1 are connected to each other through a bus (not shown).

### Image Forming Apparatus: Document Reader

The document reader 11 includes an auto document feeder (ADF), a platen glass, an optical system, and the like, and a document placed on the ADF or the platen glass is read by the optical system to obtain image data.

The image forming apparatus 1 can acquire image data not only from the document reader 11 but also from an external host device (for example, a personal computer (PC)) or the like by communication.

### Image Forming Apparatus: Image Former

The image former 12 forms an image with toner on the continuous paper P based on the acquired image data. The image former 12 includes, for example, a cyan image former 12C that forms an image of cyan (C), a magenta image former 12M that forms an image of magenta (M), a yellow image former 12Y that forms an image of yellow (Y), a black image former 12K that forms an image of black (K), an intermediate transfer belt 121, an intermediate transport roller 122, and a fixer 124. Regarding the image formers 12C to 12K, for example, a configuration including only one of the image formers 12C to 12K may be adopted, or a configuration in which a plurality of image formers are provided for only one of the image formers 12C to 12K may be adopted.

Each of the image formers 12C to 12K includes a photoconductor drum on which a toner image is formed, a charger that charges the photoconductor drum at a predetermined potential, an exposer that exposes a charged image carrier to form an electrostatic latent image according to the image data, a developer that develops the electrostatic latent image to form a toner image, and a drum cleaner that removes residual toner from the photoconductor drum.

The image formed on each photoconductor drum is sequentially primary-transferred to a predetermined position on the intermediate transfer belt 121, which is a belt-shaped intermediate transfer body. The image of each color transferred on the intermediate transfer belt 121 is secondarily transferred onto the continuous paper P, which is transported on the first transport path 13, between the intermediate transfer belt 121 and the intermediate transport roller 122.

The transport of the intermediate transfer belt 121 and the rotation of the intermediate transport roller 122 are driven by a transfer motor 123 (see FIG. 2). The transfer motor 123 is, for example, a DC motor or an AC motor suitable for speed control and torque control. A case where the transfer motor 123 is a DC brushless motor will be illustrated. In the transfer motor 123, an encoder 123a for detecting the rotation amount of the transfer motor 123 is provided.

The fixer 124 is provided on the downstream side of the intermediate transfer belt 121. The fixer 124 includes a fixing roller 125 and a pressure roller 126 for fixing the secondary transferred toner image onto the continuous paper P and a fixing motor 127 (see FIG. 2) as a rotation driving source for these. The fixing motor 127 is, for example, a DC motor or an AC motor. A case where the fixing motor 127 is a DC brushless motor will be illustrated. In the fixing motor 127, an encoder 127a for detecting the rotation amount of the fixing motor 127 is provided.

The fixer 124 performs a fixing process for fixing the toner image while transporting the continuous paper P by using a pair of fixing roller 125 and pressure roller 126 pressed against each other. A heater is provided inside the fixing roller 125. The heater heats the continuous paper P passing through a fixing nip of the fixing roller 125 and the pressure roller 126 to melt the toner image and fix the melted toner image onto the continuous paper P.

### Image Forming Apparatus: First Transport Path

As shown in FIG. 1, the first transport path 13 is a transport path for the continuous paper P from the paper feed port 131, which is provided on one end side (right side in FIG. 1) of the continuous paper P in the transport direction in the image forming apparatus 1, to a paper ejection port 132 provided on the other end side (left side in FIG. 1) of the continuous paper P in the transport direction.

On the first transport path 13, a media sensor 15 for detecting the physical property values of the continuous paper P and the intermediate transfer belt 121, the intermediate transport roller 122, and the fixer 124 of the image former 12 are arranged in order from the upstream side to the downstream side in the transport direction.

A guide roller for guiding the transport of the continuous paper P may be provided on the first transport path 13.

In the first transport path 13, the continuous paper P is transported by the intermediate transport roller 122, the transfer motor 123, and the fixing roller 125, the pressure roller 126, and the fixing motor 127 of the fixer 124 in the image former 12. However, separately from these, a transport roller may be provided on the first transport path 13.

### Image Forming Apparatus: Media Sensor

The media sensor 15 detects the physical property values of the continuous paper P as shrinkage characteristic information on the upstream side of the intermediate transfer belt 121 in the transport direction.

The media sensor 15 includes one or more sensors for measuring the paper type, grain direction, thickness, water content, rigidity, and the like as the physical property values of the continuous paper P to be fed, and outputs the measurement result to the second hardware processor 9.

The media sensor 15 includes, for example, an optical sensor having a light emitter that emits light to the continuous paper P and a light receiver that receives reflected light reflected by the continuous paper P, and can acquire the basis weight (weight per unit area of one sheet), paper type, and grain direction of the continuous paper P from the voltage value output from the light receiver.

The media sensor 15 includes a displacement sensor for detecting the thickness of the continuous paper P, a capacitance sensor for detecting the water content of the continuous paper P, and the like.

The media sensor 15 includes an acceleration sensor provided on a contact body such as an elastically supported roller, which is in contact with the continuous paper P to be transported, and can detect the rigidity of the continuous paper P from the detected acceleration.

### Image Forming Apparatus: Operation Display

The operation display 14 includes, for example, an operation interface 141 and a display 142. The operation interface 141 includes a plurality of operation buttons, and receives a user’s operation. The display 142 includes a liquid crystal display (LCD), an organic EL display, or the like. A pressure-sensitive touch panel in which transparent electrodes are arranged in a grid pattern is provided on the display. The display 142 presents various screens, such as a guide screen, and a message relevant to job execution to the user, displays an image of an operation button for touch operation, and receives a user’s touch operation.

### Image Reader

The image reader 3 includes a reader 31 serving as an image reader, a cooler 34, and a second transport path 35.

As shown in FIG. 1, the second transport path 35 guides the transport of the continuous paper P from a paper feed port 351, which is provided on one end side (right side in FIG. 1) of the continuous paper P in the transport direction in the image reader 3, to a paper ejection port 352 provided on the other end side (left side in FIG. 1) of the continuous paper P in the transport direction.

The paper feed port 351 is connected to the paper ejection port 132 of the image forming apparatus 1.

The paper ejection port 352 is connected to the post-processing device 7 and the paper collection device 6, and the continuous paper P whose image has been read is transported and post-processed by the post-processing device 7 or is collected by the paper collection device 6.

On the second transport path 35, the cooler 34 and the reader 31 are arranged in order from the upstream side to the downstream side in the transport direction.

The transport of the continuous paper P in the second transport path 35 is performed by a transport roller 76 of the post-processing device 7 on the downstream side of the image reader 3 in the transport direction or by a drive source for winding of the paper collection device 6.

A plurality of guide rollers 331 are provided on the second transport path 35, and these are roller pairs for guiding the transport of the continuous paper P with the continuous paper P interposed between the pair of rollers.

The cooler 34 cools the continuous paper P heated by the heater of the fixer 124 of the image forming apparatus 1.

The cooler 34 cools the continuous paper P transported along the second transport path 35 by blowing air.

The cooler 34 may blow air cooled by using a cooling element, such as a Pelche element.

The reader 31 includes a scanner 311 and a colorimeter 312, and the scanner 311 is arranged on the upstream side of the colorimeter 312 in the transport direction. The scanner 311 is a line sensor having a plurality of light receiving elements arranged in the CD direction, such as a charge-coupled device (CCD) sensor. The colorimeter 312 is a spectrophotometer.

The scanner 311 and the colorimeter 312 can read an image printed on the upper surface of the continuous paper P transported along the second transport path 35. The scanner 311 has a configuration having a light receiving element in a wider range than the width of the maximum-size continuous paper P expected to be used in the CD direction, and can detect the width of the transported continuous paper P in the CD direction. That is, the scanner 311 also functions as a detector for detecting the width of the continuous paper P that is a recording medium.

The read data of the image formed on the continuous paper P, which has been read by the scanner 311 and the colorimeter 312, is output to the second hardware processor 9. The second hardware processor 9 determines, for example, the suitability of the formed image, positional deviation, and the like based on the read data, and also performs a process for comparison between the read data and the image data that is the source of the formed image.

### Post-Processing Device

The post-processing device 7 includes a transport path connected to the paper ejection port 352 of the image reader 3, and performs post-processing on the continuous paper P transported from the paper ejection port 352 to the transport path as necessary. Examples of the post-processing include slitter processing, gutter slitter processing, CD cutting processing, crease processing (upward convex or downward convex), and FD/CD sewing machine processing. The above post-processing is not essential, and is performed, for example, when an execution instruction is input from the operation display 14 or the like.

As shown in FIG. 1, the post-processing device 7 includes a plurality of post-processing modules 71 to 74 arranged side by side along the transport path, a pair of transport rollers 76 for transporting the continuous paper P, a guide mechanism 75 capable of selectively feeding the continuous paper P to a transport path toward the paper collection device 6 and a branch path, which is branched from the transport path, on the downstream side of the transport rollers 76 in the transport direction, and a paper tray 78 provided on the downstream side of the branch path in the transport direction.

For example, a slitter is installed as the most upstream post-processing module 71, a downward convex creaser for performing a crease process to make a downward convex streak on the continuous paper P is installed as the post-processing module 72, a gutter slitter for cutting (gutter cutting) the paper at the center in the CD direction (paper width direction) is installed as the post-processing module 73, and a CD cutter for cutting the paper in the CD direction (paper width direction) is installed as the post-processing module 74. The number of post-processing modules can be increased or decreased, and the type of post-processing is not limited to those described above.

The pair of transport rollers 76 are rotationally driven by a transport motor 77 (see FIG. 2), which is a drive source. The transport motor 77 is provided together with an encoder 77a for detecting the number of rotations, and the speed is controlled by the second hardware processor 9.

The guide mechanism 75 includes a guide member that can move forward and backward.

When moving forward, the guide member enters the transport path toward the paper collection device 6 to guide the continuous paper P to the branch path side. When moving backward, the guide member is away from the transport path toward the paper collection device 6, so that the transport of the continuous paper P to the paper collection device 6 side is not interrupted.

The guide mechanism 75 is controlled by the second hardware processor 9, and operates in conjunction with a case where the continuous paper P is cut into sheets by the above CD cutter to guide the cut sheets to the paper tray 78 side.

### Hardware Processor

As shown in FIG. 2, the first and second hardware processors 8 and 9 include central processing units (CPUs) 81 and 91 (hard disk processors) as computers, read only memories (ROMs) 82 and 92, random access memories (RAMs) 83 and 93, and hard disk drives (HDDs) 84 and 94, respectively.

The CPUs 81 and 91 read program codes of software for performing various controls and various processes from the ROMs 82 and 92 and execute the program codes.

The ROMs 82 and 92 are used as examples of a non-volatile memory, and store programs or data necessary for the CPUs 81 and 91 to operate.

The RAMs 83 and 93 are used as examples of a volatile memory, and temporarily store variables, parameters, and the like generated during the calculation processing required for each processing performed by the CPUs 81 and 91.

The HDDs 84 and 94 are examples of a non-volatile storage, and programs for the CPUs 81 and 91 to control each unit, an operating system (OS), programs for a controller and the like, and data are stored in the HDDs 84 and 94. The non-volatile storage is not limited to the HDD, and other non-volatile memories may be used.

The recording medium in which programs executed by the hardware processors 8 and 9 are stored is not limited to the ROMs 82 and 92 and the HDDs 84 and 94. For example, recording media such as a solid state drive (SSD), a CD-ROM, and a DVD-ROM may be used.

The first hardware processor 8 is connected to the paper supply device 5 and the paper collection device 6, and performs various processes including operation control and information communication for the paper supply device 5 and the paper collection device 6 to supply and collect the continuous paper P.

Specifically, the first hardware processor 8 performs torque control for a motor (not shown), which is a drive source of the paper supply device 5, so that the tension of the continuous paper P fed from the paper supply device 5 to the image forming apparatus 1 is constant.

The first hardware processor 8 performs torque control for a motor (not shown), which is a drive source of the paper collection device 6, so that the tension of the continuous paper P fed from the image reader 3 to the paper collection device 6 is constant.

The second hardware processor 9 is connected to the document reader 11, the media sensor 15, the image former 12, and the operation display 14 of the image forming apparatus 1, the cooler 34 and the reader 31 of the image reader 3, and the post-processing device 7, and performs various processes including operation control and information communication for the document reader 11, the media sensor 15, the image former 12, and the operation display 14 of the image forming apparatus 1, the cooler 34 and the reader 31 of the image reader 3, and the post-processing device 7 to perform various processes on the continuous paper P.

The CPU 91 of the second hardware processor 9 includes a shrinkage amount outputter 911 as an outputter, a corrector 912, a post-processing controller 913, and a determiner 914.

Although the case is illustrated in which the shrinkage amount outputter 911, the corrector 912, the post-processing controller 913, and the determiner 914 are functional components realized by the CPU 91 executing a predetermined program, the shrinkage amount outputter 911, the corrector 912, the post-processing controller 913, and the determiner 914 are not limited to the functional components, and may be configured by hardware such as a dedicated processor or circuit.

The shrinkage amount outputter 911 outputs the rate of shrinkage in the FD direction that occurs in the continuous paper P due to heating and fixing by the fixer 124.

The corrector 912 corrects the size of the image formed by the image former 12 in consideration of the shrinkage rate of the continuous paper P in the FD direction output from the shrinkage amount outputter 911.

The post-processing controller 913 performs operation control in the post-processing performed by the post-processing device 7 in consideration of the shrinkage rate of the continuous paper P in the FD direction output from the shrinkage amount outputter 911.

The determiner 914 determines the suitability of the shrinkage rate of the continuous paper P in the FD direction output from the shrinkage amount outputter 911.

### Regarding Output of Shrinkage Characteristic Information of Recording Medium

The continuous paper P transported at the time of image formation is post-processed according to the setting, and the physical property values of the continuous paper P are detected by the media sensor 15 while being transported from the paper supply device 5 to the paper collection device 6. Image data is acquired by the reading of the document reader 11 or by communication from the outside, and a toner image based on the image data is transferred by the image former 12.

Then, the toner image transferred onto the continuous paper P is fixed by heating at the fixer 124 on the downstream side.

The continuous paper P on which the toner image is fixed to form an image is cooled by the cooler 34 of the image reader 3, and is read by the scanner 311 and the colorimeter 312.

Then, the continuous paper P on which the image is formed is post-processed according to the setting and is wound up by the paper collection device 6, and the image formation ends.

When cutting along the CD direction is performed as post-processing by the post-processing device 7, the continuous paper P is not collected by the paper collection device 6, but the continuous paper P is cut into sheets and transported to the paper tray 78.

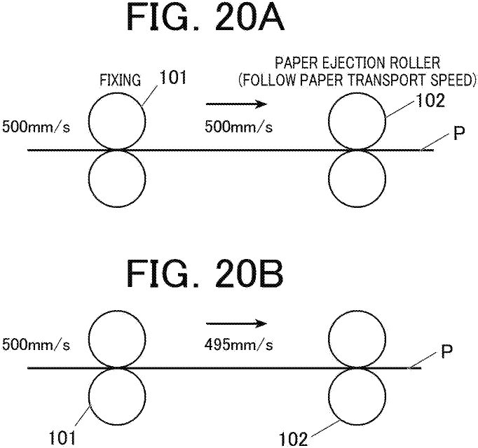

In the image forming system 10, in the process in which various processes are performed on the continuous paper P in the order described above, the continuous paper P may shrink due to heating and fixing by the fixer 124 of the image forming apparatus 1. In the case of the long continuous paper P, the transport speed may decrease depending on the shrinkage amount on the downstream side of the fixer 124 in the transport direction. For this reason, it may be difficult to output the amount of shrinkage in the transport direction occurring in the continuous paper P from the time interval at which two marks formed at a known distance therebetween on the upstream and downstream sides are detected in order by using the known method (see FIGS. 20A and 20B above).

Therefore, in the second hardware processor 9 of the image forming system 10, the shrinkage amount or the shrinkage rate of the continuous paper P in the transport direction (FD direction) due to the fixer 124 can be output from the shrinkage amount outputter 911 based on the shrinkage characteristic information of the continuous paper P and the width of the continuous paper P in the CD direction detected by the scanner 311. A case where the shrinkage rate in the FD direction is output will be illustrated.

Hereinafter, the shrinkage amount outputter 911 will be described in detail.

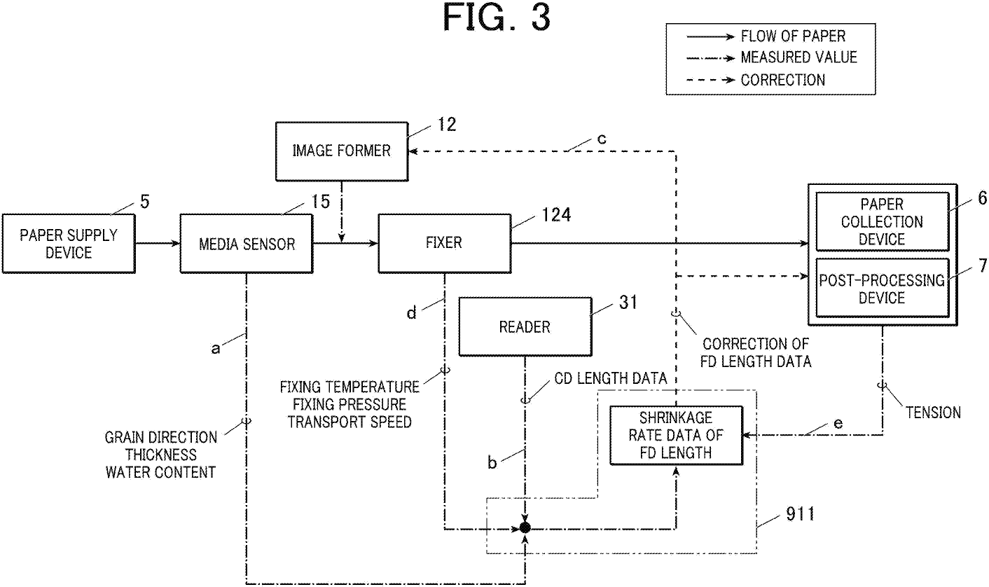

FIG. 3 is an explanatory diagram showing a flow of processing for outputting shrinkage characteristic information from the shrinkage amount outputter 911.

The “width of the continuous paper P” required for the shrinkage amount outputter 911 to output the shrinkage rate of the continuous paper P in the FD direction is the width of the continuous paper P in the CD direction (hereinafter, simply referred to as “the width of the continuous paper P”) after heating and fixing, which has passed through the fixer 124, and can be detected by the scanner 311 of the reader 31 of the image reader 3.

The width of the continuous paper P before being heated and fixed by the fixer 124 is a known value, and the shrinkage amount outputter 911 can calculate the shrinkage rate of the continuous paper P in the CD direction by comparison with the width of the continuous paper P detected by the scanner 311.

The shrinkage ratio, which is the ratio of the shrinkage rate of the continuous paper P in the FD direction to the shrinkage rate of the continuous paper P in the CD direction, correlates with various parameters belonging to the shrinkage characteristic information.

Therefore, the shrinkage amount outputter 911 calculates various parameters belonging to the shrinkage characteristic information, specifies the shrinkage ratio from the parameters, and outputs the shrinkage rate in the FD direction obtained by multiplying the shrinkage rate in the CD direction, which is obtained by reading the width of the continuous paper P, by the shrinkage ratio.

Examples of the shrinkage characteristic information of the continuous paper P include physical property values such as the grain direction, the water content, and the thickness of the continuous paper P. These can be detected by the media sensor 15.

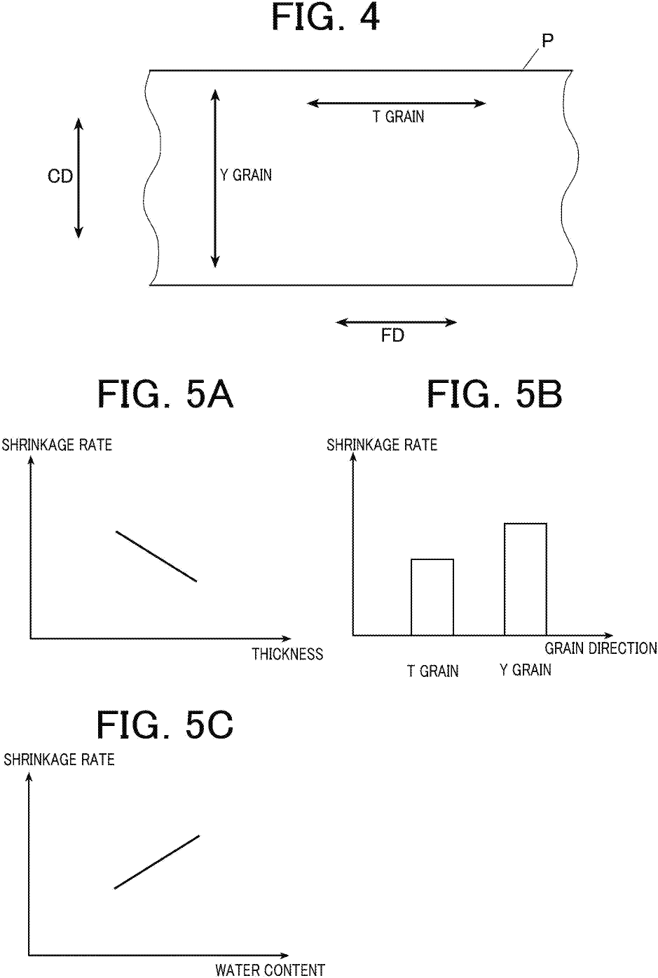

The grain direction is the direction of the fibers of the paper. As shown in FIG. 4, the paper with fibers running along the longitudinal direction (corresponding to the FD direction) of the continuous paper P is referred to as T grain, and the paper with fibers running along the short side direction (corresponding to the CD direction) of the continuous paper P is referred to as Y grain.

FIG. 5A is a relationship diagram showing the relationship between the thickness of the paper as shrinkage characteristic information and the shrinkage rate of the paper, FIG. 5B is a relationship diagram showing the relationship between the grain direction of the paper as shrinkage characteristic information and the shrinkage rate of the paper, and FIG. 5C is a relationship diagram showing the relationship between the water content of the paper as shrinkage characteristic information and the shrinkage rate of the paper.

As shown in FIG. 5A, the shrinkage rate of the continuous paper P tends to decrease as the thickness of the continuous paper P increases.

FIG. 5B shows the shrinkage rate of the continuous paper P in the longitudinal direction (FD direction). As shown in FIG. 5B, the shrinkage rate of the Y-grain paper in the FD direction tends to be higher than that of the T-grain paper in the FD direction. On the contrary, this also indicates that the shrinkage rate of the T-grain paper in the CD direction tends to be higher than that of the Y-grain paper in the CD direction.

As shown in FIG. 5C, the shrinkage rate of the continuous paper P tends to increase as the water content of the continuous paper P increases.

The second hardware processor 9 stores data of a correspondence table among the thickness, the grain direction, and the shrinkage ratio in consideration of the above characteristics and data of a correspondence table between the water content and the rate of change α in shrinkage rate based on the water content in the ROM 92 or the HDD 94 serving as a storage.

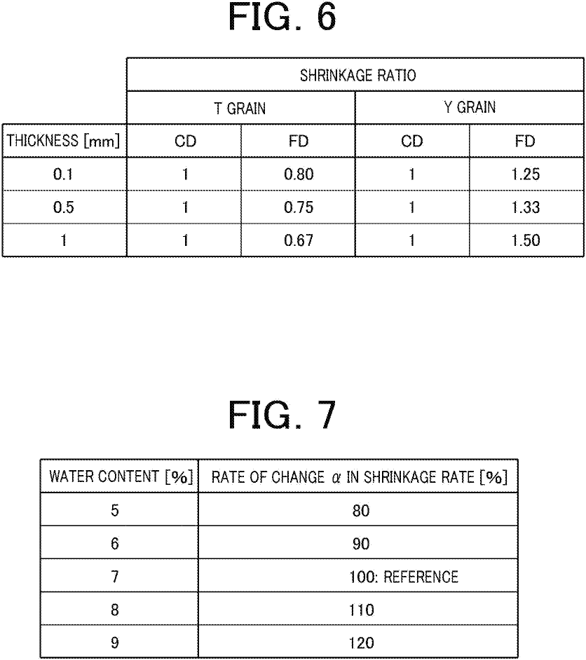

FIG. 6 is an explanatory diagram showing the content of a correspondence table among the thickness, the grain direction, and the shrinkage ratio.

In this table, the shrinkage ratio in the FD direction assuming that the shrinkage ratio in the CD direction is 1 when the continuous paper P is the T grain and the shrinkage ratio in the FD direction assuming that the shrinkage ratio in the CD direction is 1 when the continuous paper P is the Y grain are determined for each thickness of a plurality of values of the continuous paper P. The shrinkage ratio of the continuous paper P changes according to the water content, but the values of all shrinkage ratios specified in the table of FIG. 6 show the values when the water content is fixed to the reference value (for example, 7 [%]).

When the grain direction and the thickness of the continuous paper P are acquired from the media sensor 15, the shrinkage amount outputter 911 can specify the shrinkage ratio with reference to the table of FIG. 6.

FIG. 7 is an explanatory diagram showing the content of a correspondence table between the water content and the rate of change α in shrinkage rate based on the water content. As described above, when the water content changes, the shrinkage rate of the continuous paper P changes. In the table of FIG. 7, the rate of change α in the shrinkage rate of the continuous paper P in the FD direction with respect to the shrinkage rate at the water content (for example, 7 [%]) of a reference value is determined based on the curve of FIG. 5C for each water content of a plurality of values.

When the water content of the continuous paper P is acquired from the media sensor 15, the shrinkage amount outputter 911 calculates the rate of change α with reference to the table of FIG. 7, and multiplies the shrinkage rate of the continuous paper P in the FD direction based on the shrinkage ratio specified from the table of FIG. 6 by the calculated rate of change α to make a correction according to the water content.

### Operation Example (1)

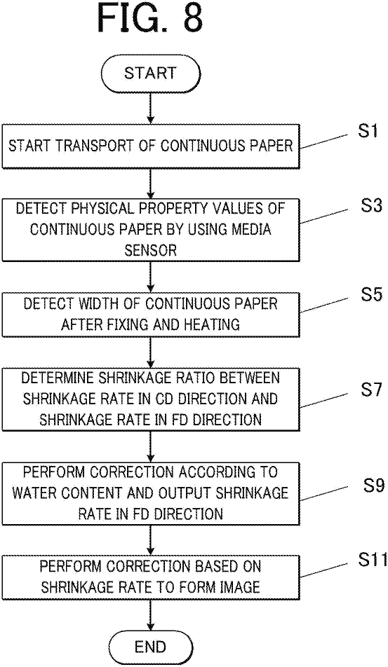

An operation example (1) in the image forming system 10 will be described with reference to FIG. 3 and the flowchart of FIG. 8.

In this operation example (1), the CPU 91 of the second hardware processor 9 plays a central role in performing overall operation control in cooperation with the CPU 81 of the first hardware processor 8. The CPU 91 performs the following operation control based on the control program stored in the ROM 92.

First, the CPU 91 starts the transport of the continuous paper P without forming an image (step S1).

That is, the CPU 91 requests the CPU 81 of the first hardware processor 8 to transport the continuous paper P by performing torque control in which the tension of the continuous paper P transported from the paper supply device 5 to the image forming apparatus 1 and the tension of the continuous paper P discharged from the post-processing device 7 to the paper collection device 6 are set to the same target torque as at the time of image formation.

The CPU 91 performs operation control to transport the continuous paper P by controlling the speed at the same target speed as at the time of image formation for the transfer motor 123 and the fixing motor 127 of the image forming apparatus 1 and the transport motor 77 of the post-processing device 7.

At this time, the CPU 91 performs control to perform heating and fixing by the fixer 124 under the same conditions as at the time of image formation even though no image is formed on the continuous paper P (fixing step).

Then, the CPU 91 causes the media sensor 15 to detect the physical property values (the thickness, the grain direction, and the water content of the paper) of the transported continuous paper P (step S3: characteristic acquisition step [arrow (a) in FIG. 3]).

The CPU 91 causes the scanner 311 of the image reader 3 to detect the width of the continuous paper P, on which heating and fixing have been performed by passing through the fixer 124 and the cooler 34, in the CD direction (step S5: width detection step [arrow (b) in FIG. 3]).

Then, the shrinkage amount outputter 911 calculates a shrinkage rate in the CD direction (referred to as Cr) due to heating and fixing by the fixer 124 based on the width of the continuous paper P in the CD direction (referred to as Cw') detected by the scanner 311 and the initial width of the continuous paper P in the CD direction (referred to as Cw), which is a known value. For example, the shrinkage rate is calculated as Cr = (Cw - Cw')/Cw.

From the paper thickness and the grain direction of the continuous paper P detected by the media sensor 15, the shrinkage amount outputter 911 specifies a shrinkage ratio (referred to as Sr) of the shrinkage rate of the continuous paper P in the FD direction to the shrinkage rate of the continuous paper P in the CD direction, with reference to the table of FIG. 6 (step S7).

The shrinkage amount outputter 911 calculates a shrinkage rate Fr in the FD direction from the shrinkage rate Cr and the shrinkage ratio Sr in the CD direction already acquired. For example, the shrinkage rate is calculated as Fr = Sr • Cr.

Then, the shrinkage amount outputter 911 specifies the rate of change α in shrinkage rate from the water content of the continuous paper P detected by the media sensor 15 with reference to the table of FIG. 7, multiplies the shrinkage rate Fr in the FD direction by the rate of change α to make a correction, and outputs a shrinkage rate αFr in the FD direction that has been corrected in consideration of the water content (step S9: shrinkage amount output step).

The corrector 912 corrects image data, which is to be formed by the image former 12, based on the shrinkage rate αFr of the continuous paper P in the FD direction on the downstream side of the fixer 124 in the transport direction, which is output from the shrinkage amount outputter 911, and the shrinkage rate Cr in the CD direction [arrow (c) in FIG. 3].

For example, the corrector 912 corrects the image data of the original image to be formed by enlarging the image by the shrinkage rate in the CD direction and the shrinkage rate in the FD direction, and the image former 12 is controlled to perform image formation based on the corrected image (step S11). Then, the process ends.

As described above, in the image forming system 10, the continuous paper P shrinks due to heating and fixing by the fixer 124, but the influence of the shrinkage on the image formed on the continuous paper P is suppressed. Therefore, it is possible to form an image with a planned size.

Thereafter, when forming a plurality of images repeatedly on the continuous paper P, it is possible to make a correction by using the shrinkage rate αFr in the FD direction and the shrinkage rate Cr in the CD direction output by the processes of steps S1 to S9. Therefore, it is not necessary to output the shrinkage rate αFr in the FD direction and the shrinkage rate Cr in the CD direction each time.

### Operation Example (2)

The shrinkage characteristic information of the continuous paper P required for the shrinkage amount outputter 911 to output the shrinkage rate of the continuous paper P in the FD direction may include the fixing condition information of the fixer 124.

By making at least one of the fixing temperature, fixing pressure, fixing speed, and fixing time, which are the fixing condition information of the fixer 124, be included in the shrinkage characteristic information, the shrinkage rate of the continuous paper P in the FD direction can be output more appropriately.

The fixing temperature, fixing pressure, fixing speed, and fixing time of the fixer 124 are individually determined according to the physical properties of the paper detected by the media sensor 15. A case will be illustrated in which the shrinkage rate of the continuous paper P in the FD direction is corrected by using the fixing temperature, the fixing pressure, and the fixing speed of the fixer 124 as shrinkage characteristic information.

The fixer 124 can control the fixing temperature by adjusting the calorific value of the heater, and the fixing temperature can be detected by a temperature sensor (not shown) provided in the fixer 124.

The fixer 124 includes an actuator (not shown) for adjusting the pressing force between the fixing roller 125 and the pressure roller 126, so that the fixing pressure can be arbitrarily controlled.

The fixer 124 can control the fixing speed by arbitrarily adjusting the rotation speed of the fixing motor 127.

The fixing time can be arbitrarily controlled from the width of the fixing nip between the fixing roller 125 and the pressure roller 126 in the transport direction and the rotation speed of the fixing motor 127.

When the paper type, grain direction, thickness, water content, and the like are detected by the media sensor 15, the second hardware processor 9 stores table data for determining the target fixing temperature, target fixing pressure, target fixing speed of the fixer 124 in the ROM 92 or the HDD 94 by using the detected paper type, grain direction, thickness, water content, and the like as parameters.

The shrinkage amount outputter 911 can acquire the fixing temperature T of the fixer 124 from the temperature sensor provided in the fixer 124, and can acquire the fixing pressure P and the fixing speed of the fixer 124 determined by the above table data.

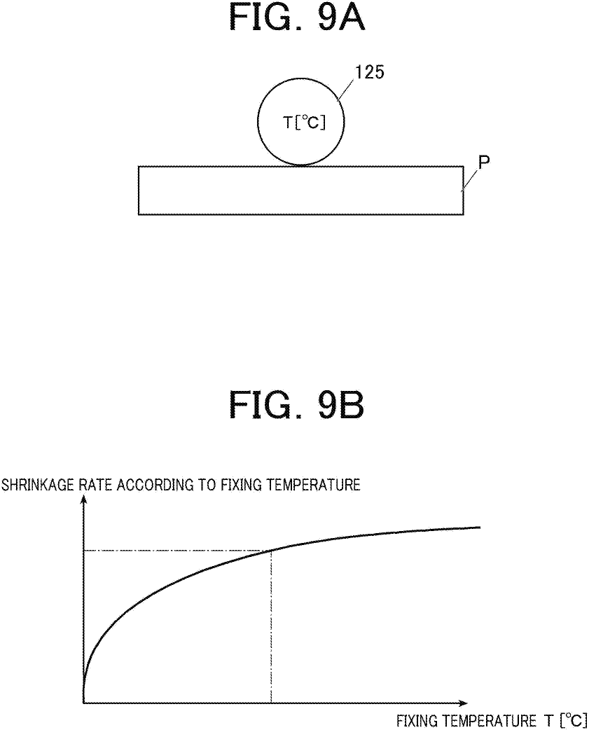

As for the fixing temperature T by the heater in the fixing roller 125 of the fixer 124 shown in FIG. 9A, as shown in the diagram of FIG. 9B, the shrinkage rate of the continuous paper P tends to increase as the fixing temperature T increases.

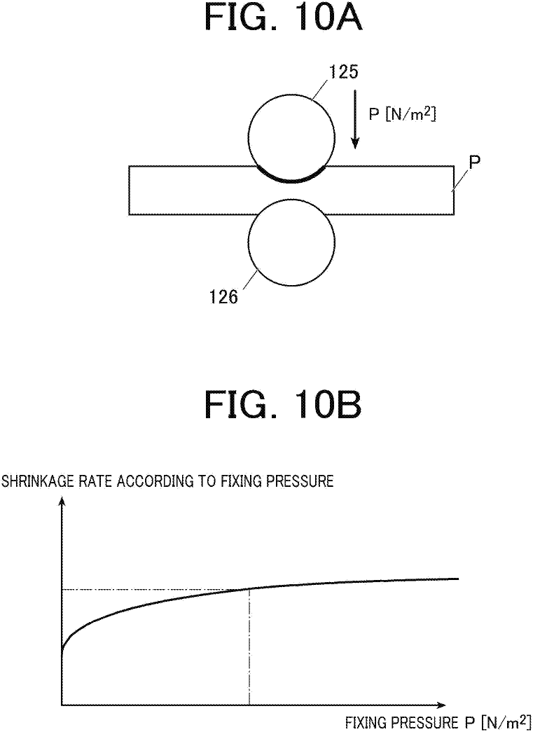

As for the fixing pressure P by the fixing roller 125 and the pressure roller 126 of the fixer 124 shown in FIG. 10A, as shown in the diagram of FIG. 10B, the shrinkage rate of the continuous paper P tends to increase as the fixing pressure P increases.

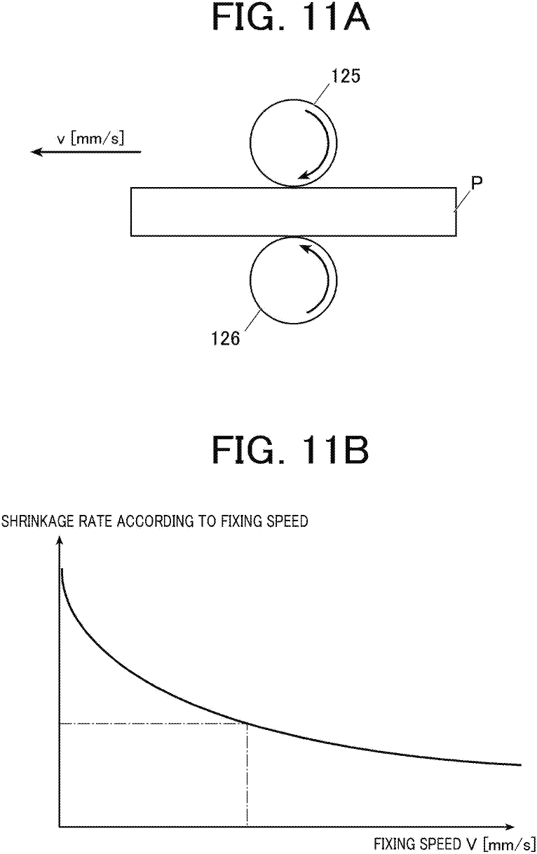

As for the fixing speed V by the fixing roller 125 and the pressure roller 126 of the fixer 124 shown in FIG. 11A, as shown in the diagram of FIG. 11B, the shrinkage rate of the continuous paper P tends to decrease as the fixing speed V increases.

The second hardware processor 9 stores the data of a correspondence table of the rate of change β of the shrinkage rate based on the fixing temperature T created based on the above tendency, the data of a correspondence table of the rate of change γ of the shrinkage rate based on the fixing pressure P, and the data of a correspondence table of the rate of change δ of the shrinkage rate based on the fixing speed V in the ROM 92 or the HDD 94.

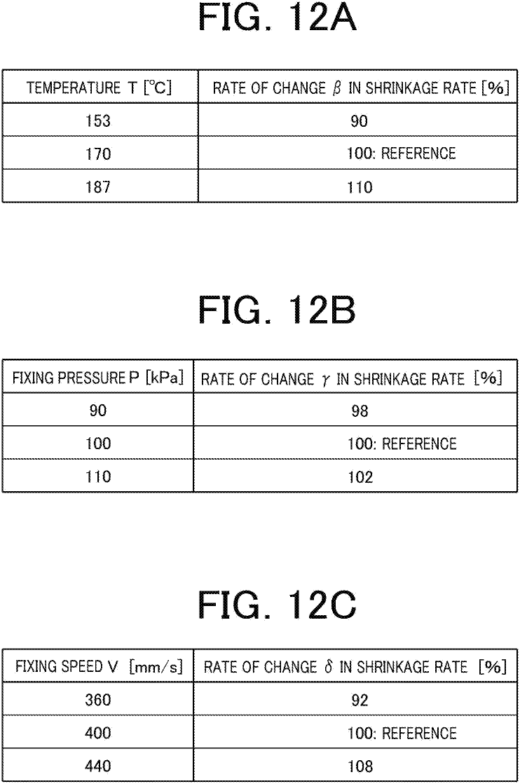

FIG. 12A is an explanatory diagram showing the content of a correspondence table between the fixing temperature T and the rate of change β in shrinkage rate based on the fixing temperature T. In the table of FIG. 12A, the rate of change β in the shrinkage rate of the continuous paper P in the FD direction with respect to the shrinkage rate at the fixing temperature T of a reference value is determined for each fixing temperature T of a plurality of values. The reference value of the fixing temperature T is 170 [°C].

FIG. 12B is an explanatory diagram showing the content of a correspondence table between the fixing pressure P and the rate of change γ in shrinkage rate based on the fixing pressure P. In the table of FIG. 12B, the rate of change γ in the shrinkage rate of the continuous paper P in the FD direction with respect to the shrinkage rate at the fixing pressure P of a reference value is determined for each fixing pressure P of a plurality of values. The reference value of the fixing pressure P is 100 [kPa].

FIG. 12C is an explanatory diagram showing the content of a correspondence table between the fixing speed V and the rate of change δ in shrinkage rate based on the fixing speed V. In the table of FIG. 12C, the rate of change δ in the shrinkage rate of the continuous paper P in the FD direction with respect to the shrinkage rate at the fixing speed V of a reference value is determined for each fixing speed V of a plurality of values. The reference value of the fixing speed V is 400 [mm/s].

When the fixing temperature T, the fixing pressure P, and the fixing speed V of the fixer 124 are acquired, the shrinkage amount outputter 911 calculates the rates of change β, γ, and δ with reference to the tables of FIGS. 12A to 12C (C) and multiplies the shrinkage rate αFr of the continuous paper P in the FD direction based on the shrinkage ratio, which is specified from the above physical property values (the thickness, the grain direction, and the water content of the paper) of the continuous paper P, by the calculated rates of change β, γ, and δ to make a correction according to the fixing condition information (fixing temperature, fixing pressure, and fixing speed).

Since the fixing time of the fixer 124 has a relative relationship with the fixing speed, it is sufficient to correct only one of the fixing time and the fixing speed.

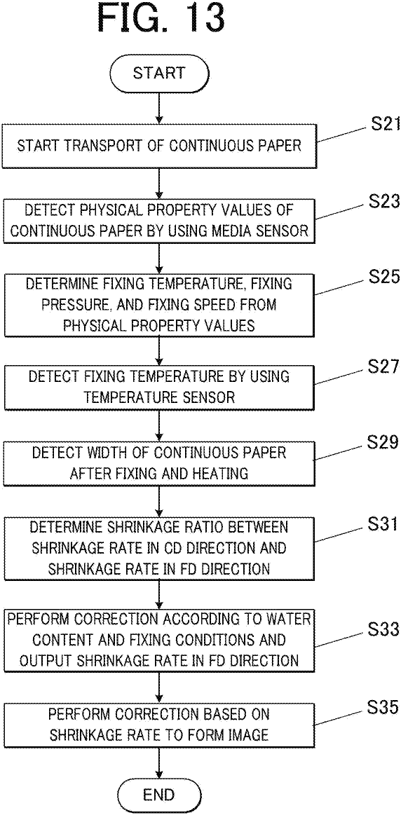

The operation example (2) in the image forming system 10 will be described with reference to FIG. 3 and the flowchart of FIG. 13.

Also in this operation example (2), the CPU 91 of the second hardware processor 9 plays a central role in performing overall operation control based on the control program.

The CPU 91 starts the transport of the continuous paper P through the first hardware processor 8 as in the case of the operation example (1) (step S21).

However, the heating of the continuous paper P by the fixer 124 is not started until the fixing conditions described later are determined.

Then, the CPU 91 causes the media sensor 15 to detect the physical property values (the thickness, the grain direction, and the water content of the paper) of the transported continuous paper P (step S23: characteristic acquisition step [arrow (a) in FIG. 3]).

The CPU 91 determines the fixing conditions (fixing temperature, fixing pressure, and fixing speed) based on the physical property values of the continuous paper P, and starts heating and fixing on the continuous paper P by the fixer 124 (step S25: fixing step).

Then, the CPU 91 detects the fixing temperature from the temperature sensor of the fixer 124 (step S27: [arrow (d) in FIG. 3]).

Then, the width of the continuous paper P, which has been heated and fixed by passing through the fixer 124, in the CD direction is detected by the scanner 311 of the image reader 3 (step S29: width detection step [arrow (b) in FIG. 3]).

Then, the shrinkage amount outputter 911 acquires the shrinkage ratio Sr in the same manner as in step S7 of FIG. 8 described above (step S31).

The shrinkage amount outputter 911 calculates the shrinkage rate Fr in the FD direction from the shrinkage rate in the CD direction, makes a correction based on the water content of the continuous paper P and the fixing conditions, and outputs a corrected shrinkage rate αβγδFr in the FD direction (step S33: shrinkage amount output step).

Also in this case, the corrector 912 corrects the image data to be formed by the image former 12 based on the output corrected shrinkage rate in the FD direction and the above shrinkage rate in the CD direction [arrow (c) in FIG. 3]. Based on the corrected image, the image is formed (step S35), and the process ends.

### Operation Example (3)

The shrinkage characteristic information required for the shrinkage amount outputter 911 to output the shrinkage rate of the continuous paper P in the FD direction may include the tension of the continuous paper P on the downstream side of the fixer 124 in the transport direction.

That is, by making the tension, which is applied to the continuous paper P at the time of transport for image formation between the fixer 124 and the transport roller 76 of the post-processing device 7, be included in the shrinkage characteristic information, the shrinkage rate of the continuous paper P in the FD direction can be output more appropriately.

By controlling the speed of the fixing motor 127 of the fixer 124 and the speed of the transport motor 77 so that the speed on the downstream side is fast, the tension of the continuous paper P between the fixer 124 and the transport roller 76 can be adjusted according to the speed difference between the target speeds.

By controlling the torque of the fixing motor 127 of the fixer 124 and the torque of the transport motor 77 so that the torque on the downstream side is large, the tension of the continuous paper P can be adjusted according to the torque difference between the target torques.

A case where speed control is performed for the fixing motor 127 and the transport motor 77 will be illustrated.

The tension of the continuous paper P at the time of transport can be arbitrarily set from, for example, the operation display 14, and the set value is stored in a predetermined storage region in the second hardware processor 9.

The second hardware processor 9 stores table data that defines the transport speeds of the fixer 124 and the transport roller 76 in order to generate an appropriate speed difference corresponding to the set tension value of the continuous paper P, and refers to the table data. However, the second hardware processor 9 may output each transport speed from the set tension by calculation.

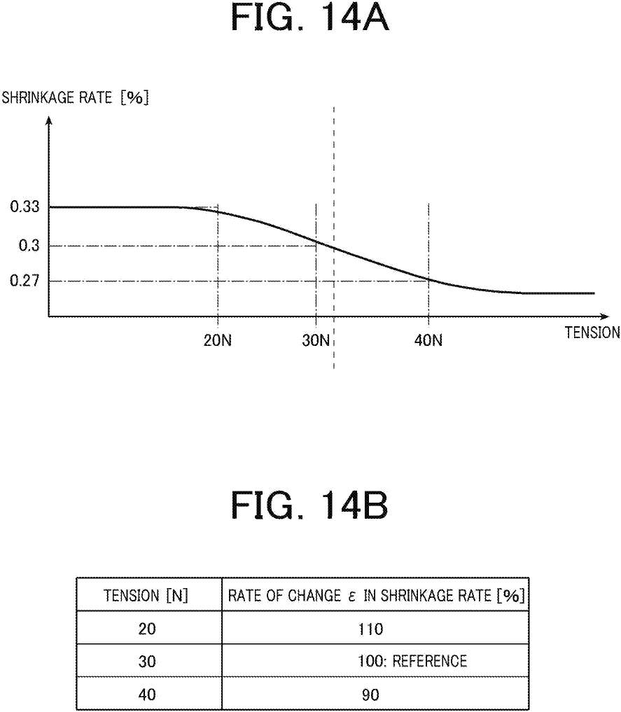

As shown in the diagram of FIG. 14A, the shrinkage rate of the continuous paper P tends to increase as the tension of the continuous paper P decreases.

As shown in FIG. 14B, the second hardware processor 9 stores the data of a correspondence table of the rate of change ε in shrinkage rate based on the tension of the continuous paper P in the ROM 92 or the HDD 94.

In this table, the rate of change ε in the shrinkage rate of the continuous paper P in the FD direction with respect to the shrinkage rate at the tension of a reference value is determined for each tension of a plurality of values. The reference value of the tension is 30 [N].

When the set value of the tension of the continuous paper P is acquired from the storage region, the shrinkage amount outputter 911 calculates the rate of change ε with reference to the table of FIG. 14B. Then, the shrinkage rate αFr of the continuous paper P in the FD direction based on the shrinkage ratio specified from the above physical property values (the thickness, the grain direction, and the water content of the paper) of the continuous paper P is multiplied by the rate of change _{ε} to make a correction according to the tension of the continuous paper P.

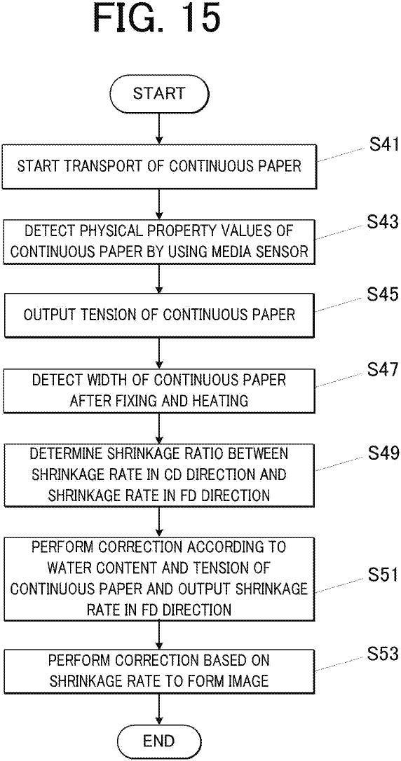

The operation example (3) in the image forming system 10 will be described with reference to FIG. 3 and the flowchart of FIG. 15.

Also in this operation example (3), the CPU 91 of the second hardware processor 9 plays a central role in performing overall operation control based on the control program.

The CPU 91 starts the transport of the continuous paper P as in the case of the operation example (1) (step S41).

The CPU 91 sets the target speeds of the fixing motor 127 of the fixer 124 and the transport motor 77 of the post-processing device 7 so as to generate a speed difference corresponding to the set tension of the continuous paper P, and performs control to maintain the target speeds.

The CPU 91 does not allow the image former 12 to form an image on the continuous paper P, but allows only the heating and fixing on the continuous paper P under the same conditions as at the time of image formation by the fixer 124 (fixing step).

Then, the CPU 91 causes the media sensor 15 to detect the physical property values (the thickness, the grain direction, and the water content of the paper) of the transported continuous paper P (step S43: characteristic acquisition step [arrow (a) in FIG. 3]).

Then, the shrinkage amount outputter 911 acquires the set tension of the continuous paper P (step S45: [arrow (e) in FIG. 3]).

Then, the width of the continuous paper P, which has been heated and fixed by passing through the fixer 124, in the CD direction is detected by the scanner 311 of the image reader 3 (step S47: width detection step [arrow (b) in FIG. 3]).

Then, the shrinkage amount outputter 911 acquires the shrinkage ratio Sr in the same manner as in step S7 of FIG. 8 described above (step S49).

The shrinkage amount outputter 911 calculates the shrinkage rate Fr in the FD direction from the shrinkage rate in the CD direction, makes a correction based on the water content and the tension of the continuous paper P, and outputs a corrected shrinkage rate αεFr in the FD direction (step S51: shrinkage amount output step).

Also in this case, the corrector 912 corrects the image data to be formed by the image former 12 based on the output shrinkage rate in the FD direction and the above shrinkage rate in the CD direction [arrow (c) in FIG. 3]. Based on the corrected image, the image is formed (step S53). Then, the process ends.

In the process of correcting the shrinkage rate in the FD direction in the above operation example (3), the correction of the shrinkage rate in the FD direction based on the fixing condition information of the fixer 124 may be performed in a multiplicative manner.

### Operation Example (4)

In the operation example (1) described above, the case where the shrinkage rate in the FD direction is output once is illustrated, but the shrinkage rate in the FD direction may be re-output according to predetermined execution conditions.

For example, the execution conditions for re-output may be those achieved by integration, such as the number of images formed on the continuous paper P, the transport length of the continuous paper P, and the elapsed time from the start of image formation.

The occurrence of a specified state, such as a case where the image size is reduced more than the threshold value as a result of the reading of the formed image by the reader 31, may be set as the execution conditions.

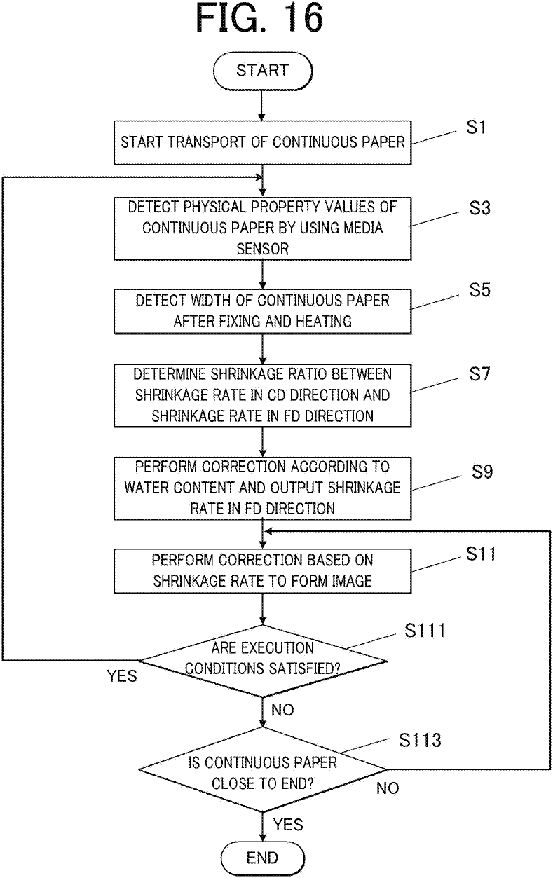

The operation example (4) in the image forming system 10 will be described with reference to FIG. 3 and the flowchart of FIG. 16.

Also in this operation example (4), the CPU 91 of the second hardware processor 9 plays a central role in performing overall operation control based on the control program.

In this operation example (4), steps having the same content as in the above operation example (1) are denoted by the same step numbers, and the same description will be omitted and only different steps will be mainly described.

When an image is formed on the continuous paper P in consideration of the shrinkage rate in the FD direction by the processes of steps S1 to S11, the shrinkage amount outputter 911 determines whether or not the execution conditions for re-outputting the shrinkage rate in the FD direction are satisfied (step S111).

If the execution conditions are not satisfied, it is determined whether or not the continuous paper P is close to the end (step S113). If the continuous paper P is close to the end, the entire image forming operation ends.

If the continuous paper P is not close to the end, the process returns to step S11 in which the corrector 912 corrects the image data in consideration of the current shrinkage rate in the FD direction and forms an image based on the image data on the continuous paper P.

On the other hand, if the execution conditions for re-outputting the shrinkage rate in the FD direction are satisfied, the process returns to step S3 to detect the physical property values of the continuous paper P, detect the width of the continuous paper P in the CD direction, acquire the shrinkage ratio, and make a correction according to the water content (steps S3 to S9), and the shrinkage rate in the FD direction is newly re-output. Then, the corrector 912 corrects the image data in consideration of the new shrinkage rate in the FD direction, and forms an image based on the image data (step S11).

As described above, in the image forming system 10, even if the shrinkage state of the continuous paper P changes for some reason, an appropriate shrinkage rate in the FD direction is newly calculated. Therefore, since the influence of the change is suppressed, image formation can be performed continuously.

In the process of correcting the shrinkage rate in the FD direction in the above operation example (4), the correction of the shrinkage rate in the FD direction based on the fixing condition information of the fixer 124 or the correction of the shrinkage rate in the FD direction based on the tension of the continuous paper P may be performed in a multiplicative manner.

### Operation Example (5)

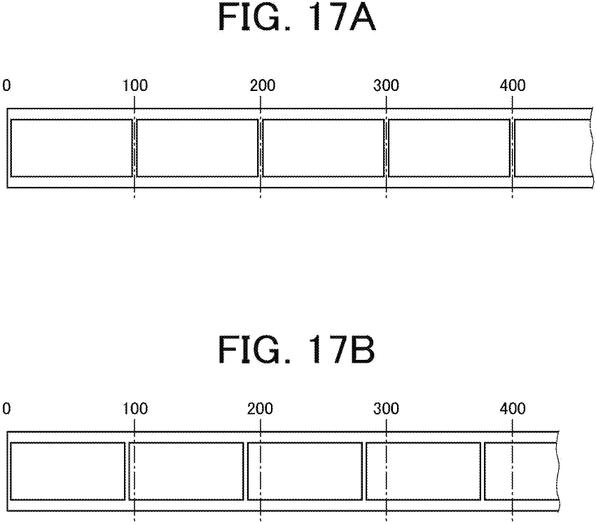

FIG. 17A is a plan view of the continuous paper P when post-processing (for example, CD cutting processing or crease processing) is appropriately performed, and FIG. 17B is a plan view of the continuous paper P when inappropriate post-processing is performed due to the influence of shrinkage in the FD direction.

When performing the CD cutting processing or the crease processing, the post-processing is performed according to the target dimensions in the FD direction by operating a cutter for performing the CD cutting or a member for performing the crease process at an appropriate timing on the assumption that the continuous paper P is transported at the specified transport speed.

When the continuous paper P is transported at the target transport speed without shrinkage, as shown in FIG. 17A, it is possible to perform the post-processing according to the appropriate target dimensions in the FD direction.

On the other hand, when the continuous paper P shrinks, the continuous paper P is restrained by the fixing roller 125 and the pressure roller 126 of the fixer 124, so that the speed decreases according to the shrinkage rate. As a result, as shown in FIG. 17B, even if the operation timing is appropriate, the post-processing causes deviation from the target dimensions.

Therefore, the post-processing controller 913 corrects the operation timing of the post-processing device 7 based on the shrinkage rate in the FD direction output from the shrinkage amount outputter 911.

Specifically, on the assumption that the transport speed of the continuous paper P decreases according to the shrinkage rate in the FD direction, the operation control is performed so that the operation timing of the post-processing device 7 is delayed by the decrease in transport speed.

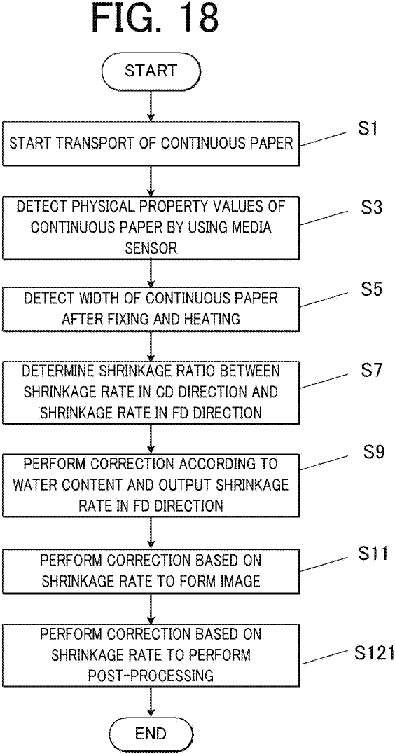

Hereinafter, an operation example (5) with post-processing in the image forming system 10 will be described with reference to FIG. 3 and the flowchart of FIG. 18.

Also in this operation example (5), the CPU 91 of the second hardware processor 9 plays a central role in performing overall operation control based on the control program.

In this operation example (5), steps having the same content as in the above operation example (1) are denoted by the same step numbers, and the same description will be omitted and only different steps will be mainly described.

After image formation with correction based on the shrinkage rate in the FD direction output from the processes of steps S1 to S11 is performed, the post-processing controller 913 performs operation control to perform post-processing (CD cutting processing and crease processing) on the continuous paper P, on which an image is formed, at a timing in consideration of the shrinkage rate in the FD direction (step S121), and ends the process.

For example, a case is illustrated in which images of 90 [mm] are formed at distances of 100 [mm] in the FD direction and post-processing is performed at a target transport speed of 100 [mm/s] and at distances of 100 [mm].

Under the above assumption, when shrinkage in the FD direction due to fixing occurs at a shrinkage rate of 1 [%], the transport speed of the continuous paper P is 99 [mm/s]. On the other hand, since the formed image is corrected according to the shrinkage rate output from the shrinkage amount outputter 911, the images of 90 [mm] are formed at distances of 100 [mm] regardless of the shrinkage of the continuous paper P.

On the other hand, the post-processing controller 913 makes a correction to delay the operation timing of the post-processing device 7 by 100/99 times the normal time, thereby performing control to perform the post-processing at intervals of 100/99 [s]. Therefore, since the post-processing, such as CD cutting, is performed at distances of 100 [mm], it is possible to perform the post-processing at the appropriate position of the formed image.

In the process of correcting the shrinkage rate in the FD direction in the above operation example (5), the correction of the shrinkage rate in the FD direction based on the fixing condition information of the fixer 124 or the correction of the shrinkage rate in the FD direction based on the tension of the continuous paper P may be performed in a multiplicative manner.

### Operation Example (6)

In the operation example (1) described above, the case has been illustrated in which, when the shrinkage rate in the FD direction is output, the corrector 912 makes a correction in consideration of the output shrinkage rate in the FD direction to form an image. However, a process of determining the suitability according to the magnitude of the shrinkage rate in the FD direction by the determiner 914 may be added.

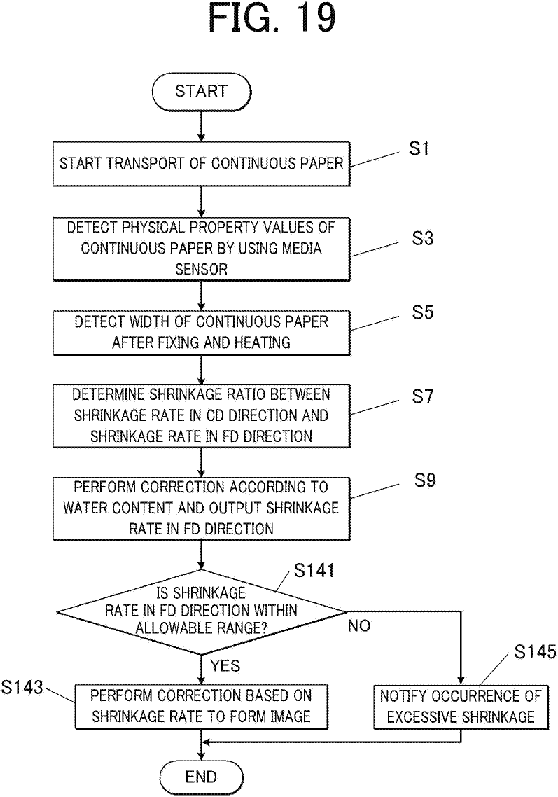

Hereinafter, an operation example (6) in which the determination process by the determiner 914 is added in the image forming system 10 will be described with reference to FIG. 3 and the flowchart of FIG. 19.

Also in this operation example (6), the CPU 91 of the second hardware processor 9 plays a central role in performing overall operation control based on the control program.

In this operation example (6), steps having the same content as in the above operation example (1) are denoted by the same step numbers, and the same description will be omitted and only different steps will be mainly described.

When the shrinkage rate in the FD direction is output from the processes of steps S1 to S9, the determiner 914 determines whether or not the shrinkage rate in the FD direction is within the allowable range by comparing the shrinkage rate in the FD direction with the specified threshold value (step S141).

Then, when the determiner 914 determines that the output shrinkage rate in the FD direction is within the allowable range based on the threshold value, the corrector 912 corrects the image data in consideration of the shrinkage rate in the FD direction to form an image on the continuous paper P based on the corrected image data (step S143), and the process ends.

When the determiner 914 determines that the output shrinkage rate in the FD direction is out of the allowable range based on the threshold value, image formation is not performed, and the CPU 91 performs notification processing such as notifying that excessive shrinkage has occurred in the continuous paper P, for example, through the operation display 14 or the like, and ends the process.

In the process of correcting the shrinkage rate in the FD direction in the above operation example (6), the correction of the shrinkage rate in the FD direction based on the fixing condition information of the fixer 124 or the correction of the shrinkage rate in the FD direction based on the tension of the continuous paper P may be performed in a multiplicative manner.

### Technical Effect of Embodiment of Invention

As described above, in the image forming system 10, the second hardware processor 9 includes the shrinkage amount outputter 911 that outputs the shrinkage rate of the continuous paper P in the FD direction due to the fixer 124 based on the shrinkage characteristic information of the continuous paper P and the width of the continuous paper P detected by the scanner 311 of the image reader 3. Therefore, it is possible to calculate the shrinkage rate in the FD direction more accurately by suppressing the influence of the decrease in transport speed after shrinkage.

In the image forming system 10, since the shrinkage characteristic information of the continuous paper P includes the grain direction, water content, and thickness of the paper, the shrinkage amount outputter 911 can output the shrinkage rate of the continuous paper P in the FD direction more accurately in consideration of the influence of the grain direction, water content, and thickness of the paper that affect the shrinkage rate of the continuous paper P.

The second hardware processor 9 stores a table as information for specifying the shrinkage ratio of the continuous paper P in the CD direction and the FD direction for each of a plurality of grain directions and thicknesses of the paper, and the shrinkage amount outputter 911 outputs the shrinkage rate in the FD direction in consideration of the table. Therefore, it is possible to quickly output the shrinkage rate in the FD direction.

In the image forming system 10, when the shrinkage characteristic information of the continuous paper P includes at least one of the fixing temperature, the fixing pressure, the fixing speed, and the fixing time, which are the fixing condition information, the shrinkage amount outputter 911 can output the shrinkage rate of the continuous paper P in the FD direction more accurately in consideration of the influence of the fixing temperature, the fixing pressure, the fixing speed, or the fixing time that affects the shrinkage rate of the continuous paper P.

In the image forming system 10, when the shrinkage characteristic information of the continuous paper P includes the tension of the continuous paper P between the fixer 124 and the transport roller 76, the shrinkage amount outputter 911 can output the shrinkage rate of the continuous paper P in the FD direction more accurately in consideration of the influence of the tension of the paper that affects the shrinkage rate of the continuous paper P.

The tension of the continuous paper P is determined based on the transport speed difference or the torque difference between the fixer 124 and the transport roller 76. Therefore, since the tension of the continuous paper P can be kept constant by controlling the drive source for the fixer 124 and the transport roller 76, the shrinkage rate of the continuous paper P in the FD direction can be kept constant. Therefore, when forming an image on the continuous paper P or correcting the operation of the post-processing on the continuous paper P according to the shrinkage rate of the continuous paper P in the FD direction, it is possible to make an appropriate correction for a long period of time with the shrinkage rate once output.

In the image forming system 10, the second hardware processor 9 includes the corrector 912 that corrects the size of the image, which is formed by the image former 12, based on the shrinkage rate of the continuous paper P in the FD direction output from the shrinkage amount outputter 911. Therefore, it is possible to optimize the size of the image by suppressing the shrinkage of the formed image.

In the image forming system 10, the second hardware processor 9 includes the determiner 914 that determines whether or not the shrinkage state is suitable based on the shrinkage rate output from the shrinkage amount outputter 911. Therefore, when the shrinkage of the continuous paper P is excessive, it is possible to determine whether or not to perform a process such as image formation.

In the image forming system 10, the scanner 311 is a line sensor having a plurality of light receiving elements arranged along the CD direction. Therefore, since it is possible to accurately detect the width of the shrunk continuous paper P in the CD direction, it is also possible to accurately calculate the shrinkage rate in the FD direction.

Since the scanner 311 is a sensor capable of reading an image formed on the continuous paper P, the scanner 311 provided as an image reader can also be used as a detector. Therefore, it is not necessary to provide a dedicated detector for detecting the width of the continuous paper P in the CD direction. As a result, it becomes easy to manufacture the device from the viewpoint of reducing the number of components such as sensors, and it is possible to reduce the size of the device because the extra installation space is not required.

In the image forming system 10, the second hardware processor 9 includes the post-processing controller 913 that controls the operation of the post-processing performed by the post-processing device 7 by reflecting the shrinkage rate output from the shrinkage amount outputter 911. Therefore, it is possible to perform post-processing on the image formed on the continuous paper P at an appropriate position in the FD direction.

In particular, in the case of cutting processing along the CD direction and a crease process along the CD direction, the execution position in the FD direction is important. Since the operation is optimized by the post-processing controller 913, it is possible to maintain high processing accuracy even if shrinkage of the continuous paper P occurs.

### Others

The details shown in the embodiments of the invention can be appropriately changed without departing from the spirit of the invention.

For example, the shrinkage characteristic information of the continuous paper P may include information indicating the paper type, basis weight, or rigidity.

The paper type and the basis weight can be detected by the above-described optical sensor of the media sensor 15.

The rigidity can be detected by the above-described acceleration sensor of the media sensor 15.

Since the paper type, the basis weight, and the rigidity all correlate with the shrinkage rate of the continuous paper P in the FD direction, it is preferable to prepare the data of a correspondence table of the rate of change in shrinkage rate based on the paper type, the basis weight, or the rigidity, such as that shown in FIG. 7 described above, in the ROM 92 or the HDD 94 serving as a storage.

Then, when the shrinkage amount outputter 911 outputs the shrinkage rate of the continuous paper P in the FD direction, it is preferable to correct the shrinkage rate in the FD direction based on the rate of change corresponding to the paper type, the basis weight, or the rigidity detected by the media sensor 15 by referring to the correspondence table.

As a result, it is possible to calculate the shrinkage rate of the continuous paper P in the FD direction more accurately.

Although the continuous paper P is exemplified as the recording medium of the image forming system 10, the continuous paper P is not limited thereto, and a long paper (long sheet) may be used as the recording medium. The recording medium is not limited to paper, and may be a sheet material formed of another material such as resin.

For example, when a long paper having a length in the FD direction exceeding the path length from the fixer 124 to the scanner 311 is used as a recording medium, it is difficult to detect the shrinkage rate in the FD direction because the reading is performed by the scanner 311 in a state in which the transport speed is reduced due to the shrinkage of the fixer 124. Therefore, even in the case of such a long paper, it is effective to output the shrinkage rate in the FD direction from the width of the long paper in the CD direction.

In the embodiment of the invention described above, the shrinkage rate of the continuous paper P in the FD direction is output. However, the shrinkage amount of the recording medium in the FD direction may be output instead of the shrinkage rate or together with the shrinkage rate.

In this case, by providing a means for detecting the transport amount of the continuous paper P without considering the shrinkage due to the fixer 124 or a means for detecting the transport amount of the continuous paper P on the upstream side of the fixer 124 in the transport direction, it is possible to output the shrinkage amount by multiplying the transport amount obtained from the means by the shrinkage rate in the FD direction output from the shrinkage amount outputter 911.

The above shrinkage amount is the amount of shrinkage with respect to the length in the FD direction as a reference, such as the amount of shrinkage occurring with respect to a predetermined transport amount (for example, 1 [m]), the amount of shrinkage occurring per unit time, and the amount of shrinkage with respect to the known size of the formed image in the FD direction.

Although embodiments of the present invention have been described and illustrated in detail, the disclosed embodiments are made for purposes of illustration and example only and not limitation. The scope of the present invention should be interpreted by terms of the appended claims.

What is claimed is:

1. A control device of an image forming system including an image former that forms an image on a recording medium formed of a continuous sheet or a long sheet, the control device comprising:
a hardware processor that calculates a width of the recording medium on a downstream side of a fixer included in the image former in a transport direction of the recording medium and outputs a shrinkage amount or a shrinkage rate of the recording medium in the transport direction due to the fixer based on the width of the recording medium and shrinkage characteristic information of the recording medium.

2. The control device according to claim 1,
wherein the shrinkage characteristic information of the recording medium includes information indicating a paper type.

3. The control device according to claim 1,
wherein the shrinkage characteristic information of the recording medium includes information indicating a grain direction of paper.

4. The control device according to claim 3, further comprising:
a storage that stores information for specifying a shrinkage ratio between a shrinkage rate of the recording medium in a width direction and a shrinkage rate of the recording medium in the transport direction for each of a plurality of grain directions of the paper,
wherein the hardware processor outputs the shrinkage amount or the shrinkage rate in consideration of the information for specifying the shrinkage ratio.

5. The control device according to claim 1,
wherein the shrinkage characteristic information of the recording medium includes information indicating at least one of a water content and a thickness of paper.

6. The control device according to claim 1,
wherein the shrinkage characteristic information of the recording medium includes information indicating at least one of a basis weight and a rigidity of paper.

7. The control device according to claim 1,
wherein the shrinkage characteristic information of the recording medium includes fixing condition information.

8. The control device according to claim 7,
wherein the fixing condition information includes information indicating at least one of a fixing temperature, a fixing pressure, a fixing speed, and a fixing time.

9. The control device according to claim 1,
wherein the shrinkage characteristic information of the recording medium includes a tension of the recording medium on the downstream side of the fixer in the transport direction.

10. The control device according to claim 9,
wherein the shrinkage characteristic information of the recording medium includes, as the tension of the recording medium, a tension of the recording medium between the fixer and a transport roller for the recording medium provided on the downstream side of the fixer in the transport direction.

11. The control device according to claim 10,
wherein the tension of the recording medium is based on a transport speed difference or a torque difference between the fixer and the transport roller.

12. The control device according to claim 1,
wherein the hardware processor corrects a size of an image formed by the image former based on the output shrinkage amount or shrinkage rate.

13. The control device according to claim 1,
wherein the hardware processor determines whether or not the output shrinkage amount or shrinkage rate is suitable.

14. An image forming system, comprising:
the control device according to claim 1.

15. The image forming system according to claim 14, further comprising:
a detector that detects the width of the recording medium on the downstream side of the fixer of the image former in the transport direction of the recording medium,
wherein the detector is a sensor having a plurality of light receiving elements arranged along the width direction of the recording medium.

16. The image forming system according to claim 15,
wherein the sensor reads an image formed on the recording medium.

17. The image forming system according to claim 14, further comprising:
a post-processor that performs post-processing on the recording medium on which an image is formed,
wherein the control device includes a hardware processor that controls an operation of the post-processor by reflecting the shrinkage amount or the shrinkage rate.

18. The image forming system according to claim 17,
wherein the post-processor performs, as the post-processing, cutting or crease processing along a width direction of the recording medium.

19. A control method of an image forming system including an image former that forms an image on a recording medium formed of a continuous sheet or a long sheet, the control method comprising:
calculating a width of the recording medium on a downstream side of a fixer included in the image former in a transport direction of the recording medium and outputting a shrinkage amount or a shrinkage rate of the recording medium in the transport direction due to the fixer based on the width of the recording medium and shrinkage characteristic information of the recording medium.

20. A non-transitory recording medium storing a program causing a computer of an image forming system including an image former that forms an image on a recording medium formed of a continuous sheet or a long sheet to perform:
calculating a width of the recording medium on a downstream side of a fixer included in the image former in a transport direction of the recording medium and outputting a shrinkage amount or a shrinkage rate of the recording medium in the transport direction due to the fixer based on the width of the recording medium and shrinkage characteristic information of the recording medium.
